(19) United States
(12) Patent Application Publication
(10) Pub. No.: US 2026/0268635 A1
(43) Pub. Date: Sep. 10, 2026

(54) INFORMATION PROCESSING APPARATUS, INFORMATION PROCESSING METHOD, AND NON-TRANSITORY RECORDING MEDIUM

(71) Applicant: NEC Corporation, Tokyo (JP)

(72) Inventor: Wataru FUJII, Tokyo (JP)

(73) Assignee: NEC Corporation, Tokyo (JP)

(21) Appl. No.: 19/165,610

(22) PCT Filed: Mar. 20, 2023
(86) PCT No.: PCT/JP2023/010946

§ 371 Date: Sep. 16, 2025

(51) Int. Cl. G06V 10/60; G06T 7/70; G06V 10/46; G06V 40/16

(52) U.S. Cl. CPC G06V 10/60; G06T 7/70; G06V 10/46; G06V 40/171; G06T 2207/30201

(57) ABSTRACT

An information processing apparatus including:
an acquisition means for acquiring an image including an eye area of a target;
a glasses determination means for determining whether the target included in the image is wearing glasses;
a power determination means for determining a power of the glasses based on the image in case the target is wearing glasses; and
an output means for outputting information to the target depending on the power determination result of the power determination means.

### TECHNICAL FIELD

This disclosure relates to the technical field of information processing apparatus, information processing methods, and recording media.

### BACKGROUND ART

Patent Literature 1 describes a technology for illuminating the eyes of a person to be recognized, imaging the eyes of the person to be recognized as eye images with an imaging section, detecting glasses reflections from the eye images, and, when glasses reflections are detected, instructing the person to be recognized to move or change the direction of their face.

Patent Literature 2 describes a method of creating a histogram of the brightness values of eye images, storing the created histogram, calculating the difference between the power corresponding to each brightness value in the created histogram and the power corresponding to a brightness value that is one less than the brightness value, comparing the difference with a first threshold value as a first comparison, the difference between the power corresponding to the brightness value and the power corresponding to the brightness value one greater than the brightness value, and the relationship between the difference and a second threshold value as a second comparison, and determining whether or not the eye image includes reflection light from glasses based on the comparison results of the first comparison and the second comparison.

Patent Literature 3 describes a technology for determining the characteristics of glasses based on the first contour position indicating the position of the face contour as detected from the acquired user face image data without glasses and the second contour position indicating the position of the face contour as detected from the acquired user face image data with glasses.

Patent Literature 4 describes a technology for controlling the display size of the image captured by an infrared camera so that the ratio of the distance between the two eye position targets to the display size of the image captured by the infrared camera is increased when the person being recognized is wearing glasses for correcting myopia, by superimposing the position targets of both eyes on the display apparatus during iris recognition.

### CITATION LIST

### Patent Literature

Patent Literature 1: JP2005-025439A
Patent Literature 2: JP 2006-318374A
Patent Literature 3: JP 2015-025859A
Patent Literature 4: JP 2017-134657A

### SUMMARY

It is an example object of this disclosure to provide an information processing apparatus, an information processing method, and a recording medium that are intended to improve the techniques/technologies disclosed in Citation List.

### SOLUTION TO PROBLEM

An information processing apparatus according to an example aspect includes: an acquisition means for acquiring an image including an eye area of a target; a glasses determination means for determining whether the target included in the image is wearing glasses; a power determination means for determining a power of the glasses based on the image in case the target is wearing glasses; and an output means for outputting information to the target depending on the power determination result of the power determination means.

An information processing method according to an example aspect includes acquiring an image including an eye area of a target; determining whether the target included in the image is wearing glasses; determining a power of the glasses based on the image in case the target is wearing glasses; and outputting information to the target depending on the power determination result.

A recording medium according to an example aspect is a recording medium on which a computer program that allows a computer to execute an information processing method is recorded, the information processing method including acquiring an image including an eye area of a target; determining whether the target included in the image is wearing glasses; determining a power of the glasses based on the image in case the target is wearing glasses; and outputting information to the target depending on the power determination result.

### BRIEF DESCRIPTION OF DRAWINGS

FIG. 1 is a block diagram illustrating a configuration of an information processing apparatus according to this disclosure.

FIG. 2 is a block diagram illustrating a configuration of an information processing apparatus according to this disclosure.

FIG. 3 is a flowchart illustrating a flow of an information processing operation of an information processing apparatus according to this disclosure.

FIG. 4 is a block diagram illustrating a configuration of an information processing apparatus according to this disclosure.

FIG. 5 is a flowchart illustrating a flow of an information processing operation of an information processing apparatus according to this disclosure.

FIG. 6 is a block diagram illustrating a configuration of an information processing apparatus according to this disclosure.

FIG. 7 is a flowchart illustrating a flow of an information processing operation of an information processing apparatus according to this disclosure.

FIG. 8 is a block diagram illustrating a configuration of an information processing apparatus according to this disclosure.

FIG. 9 is a flowchart illustrating a flow of an information processing operation of an information processing apparatus according to this disclosure.

FIG. 10 is a block diagram illustrating a configuration of an information processing apparatus according to this disclosure.

FIG. 11 is a flowchart illustrating a flow of an information processing operation of an information processing apparatus according to this disclosure.

### DESCRIPTION OF EXAMPLE EMBODIMENTS

The following describes embodiments of the information processing apparatus, the information processing method, and the recording medium with reference to the drawings.

### 1: First Example Embodiment

A first embodiment of an information processing apparatus, information processing method, and recording medium is described. The first embodiment of the information processing apparatus, information processing method, and recording medium will be described below using an information processing apparatus 1 to which the first embodiment of the information processing apparatus, information processing method, and recording medium is applied.

### 1-1: Configuration of the Information Processing Apparatus 1

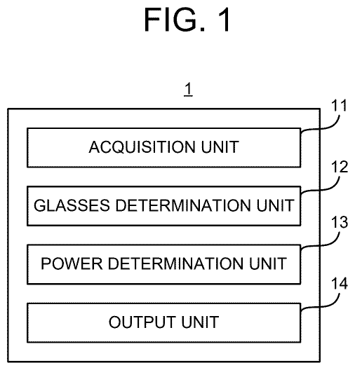

FIG. 1 is a block diagram showing the configuration of the information processing apparatus 1 according to the first embodiment. As shown in FIG. 1, the information processing apparatus 1 includes an acquisition unit 11, a glasses determination unit 12, a power determination unit 13, and an output unit 14. The acquisition unit 11 acquires an image including an eye area of a target. The glasses determination unit 12 determines whether the target in the image is wearing glasses. The power determination unit 13 determines the power of the glasses based on the image in case the target is wearing the glasses. The output unit 14 outputs information to the target based on the determination result of the power determination unit 13. The determination of the power of the glasses may be a determination of the power of the glasses itself. Alternatively, the determination of the power of the glasses may be a determination of the possibility that the image is affected by the power of the glasses.

### 1-2: Technical Effects of the Information Processing Apparatus 1

The information processing apparatus 1 according to the first embodiment can determine the power of the glasses based on the image including the target in case the target is wearing the glasses, and output information corresponding to the power of the glasses to the target.

### 2: Second Example Embodiment

Next, a second embodiment of the information processing apparatus, information processing method, and recording medium will be described. The second embodiment of the information processing apparatus, information processing method, and recording medium will be described using an information processing apparatus 2 to which the second embodiment of the information processing apparatus, information processing method, and recording medium is applied.

### 2-1: Configuration of the Information Processing Apparatus 2

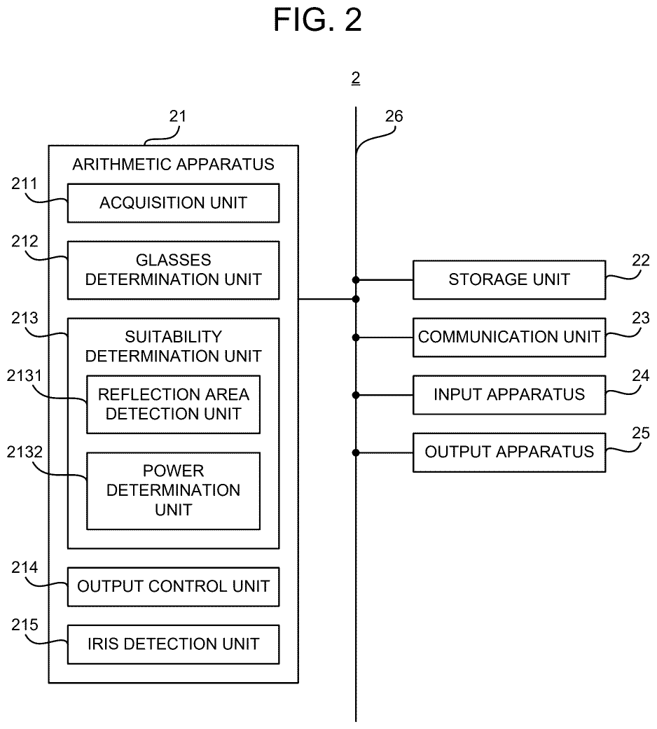

FIG. 2 is a block diagram showing the configuration of the information processing apparatus 2 according to the second embodiment. As shown in FIG. 2, the information processing apparatus 2 is provided with an arithmetic apparatus 21 and a storage apparatus 22. Furthermore, the information processing apparatus 2 may include a communication apparatus 23, an input apparatus 24, and an output apparatus 25. However, the information processing apparatus 2 may not include at least one of the communication apparatus 23, the input apparatus 24, and the output apparatus 25. The arithmetic apparatus 21, the storage apparatus 22, the communication apparatus 23, the input apparatus 24, and the output apparatus 25 may be connected via a data bus 26.

The arithmetic apparatus 21 may be, for example, a CPU (Central Processing Unit), a GPU (Graphics Processing Unit), and/or an FPGA (Field Programmable Gate Array). The arithmetic apparatus 21 reads a computer program. For example, the arithmetic apparatus 21 may read a computer program stored in the storage apparatus 22. For example, the arithmetic apparatus 21 may read a computer program stored in a computer-readable and non-temporary recording medium using a recording medium reading apparatus (e.g., the input apparatus 24 described later) provided in the information processing apparatus 2. The arithmetic apparatus 21 may obtain (i.e., download or read) a computer program from an apparatus not shown, which is disposed outside the information processing apparatus 2, via the communication apparatus 23 (or other communication apparatus). The arithmetic apparatus 21 executes the read computer program. As a result, logical functional blocks for executing the operations to be performed by the information processing apparatus 2 are realized within the arithmetic apparatus 21. In other words, the arithmetic apparatus 21 functions as a controller for realizing logical functional blocks for executing the operations (i.e., processing) to be performed by the information processing apparatus 2.

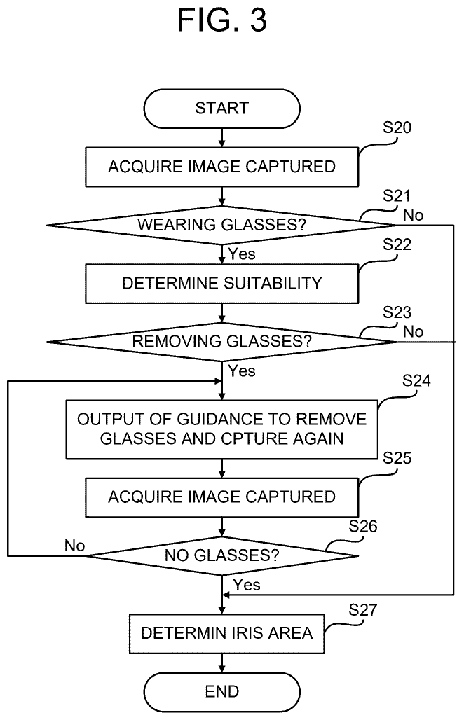

FIG. 2 shows an example of logical functional blocks realized within the arithmetic apparatus 21 for executing information processing operations. As shown in FIG. 2, the arithmetic apparatus 21 includes an acquisition unit 211, which is a specific example of the “acquisition means” described in the Supplementary Note described later, a glasses determination unit 212, which is a specific example of the “glasses determination means” described in the Supplementary Note described later, a suitability determination unit 213, which is a specific example of the “power determination means” described in the Supplementary Note described later, and an output control unit 214, which is a specific example of the “output means” described in the Supplementary Note described below, are realized. The suitability determination unit 213 may include a reflection area detection unit 2131 and a power determination unit 2132. Additionally, an iris detection unit 215 may be implemented within the arithmetic apparatus 21. However, the iris detection unit 215 need not be implemented within the arithmetic apparatus 21. The details of the operation of each of the acquisition unit 211, the glasses determination unit 212, the suitability determination unit 213, the output control unit 214, and the iris detection unit 215 will be explained later with reference to FIG. 3.

The storage apparatus 22 is capable of storing desired data. For example, the storage apparatus 22 may temporarily store the computer program executed by the arithmetic apparatus 21. The storage apparatus 22 may also temporarily store data temporarily used by the arithmetic apparatus 21 in case the arithmetic apparatus 21 is executing a computer program. The storage apparatus 22 may store data that the information processing apparatus 2 stores for long-term preservation. Note that the storage apparatus 22 may be RAM (Random Access Memory), ROM (Read Only Memory), a hard disk apparatus, an optical magnetic disk apparatus, an SSD (Solid State Drive), and a disk array apparatus. In other words, the storage apparatus 22 may include a non-temporary recording medium.

The communication apparatus 23 is capable of communicating with an external apparatus of the information processing apparatus 2 via an unillustrated communication network. The communication apparatus 23 may be a communication interface based on standards such as Ethernet (registered trademark), Wi-Fi (registered trademark), Bluetooth (registered trademark), or USB (Universal Serial Bus).

The input apparatus 24 is an apparatus that accepts information input to the information processing apparatus 2 from outside the information processing apparatus 2. For example, the input apparatus 24 may include an operation apparatus (e.g., at least one of a keyboard, a mouse, and a touch panel) that can be operated by an operator of the information processing apparatus 2. For example, the input apparatus 24 may include a reading apparatus capable of reading information recorded as data on a recording medium that can be attached to the information processing apparatus 2.

The output apparatus 25 is an apparatus that outputs information to the outside of the information processing apparatus 2. For example, the output apparatus 25 may output information as images. In other words, the output apparatus 25 may include a display apparatus (a so-called display) capable of displaying images indicating the information to be output. For example, the output apparatus 25 may output information as audio. In other words, the output apparatus 25 may include an audio apparatus (a so-called speaker) capable of outputting audio. Furthermore, for example, the output apparatus 25 may output information onto paper. In other words, the output apparatus 25 may include a printing apparatus (a so-called printer) capable of printing desired information onto paper.

### 2-2: Information Processing Operations Performed by the Information Processing Apparatus 2

Referring to FIG. 3, the flow of information processing performed by the information processing apparatus 2 will be described. FIG. 3 is a flowchart showing the flow of information processing performed by the information processing apparatus 2. The information processing apparatus 2 according to this embodiment may be applied to a situation in which iris information of the target is registered as registration information for biometric recognition.

As shown in FIG. 3, the acquisition unit 211 acquires an image including the eye area of the target (step S20). The acquisition unit 211 acquires an image including the eye area of the target that has been captured under predetermined capturing conditions.

The acquisition unit 211 may acquire an image that has been captured so that an iris area of a predetermined size is included in the image. The acquisition unit 211 may also acquire an image that has been captured by the camera of a target whose face is facing straight toward the camera. The output control unit 214 may output, in case of capturing an image, guide information that guides the target so that the iris region of a predetermined size is included in the image, for example. Alternatively, the output control unit 214 may output the guide information to guide the target to assume a posture where the face is directly facing the camera. For example, the output control unit 214 may display an image superimposed with a guide frame for aligning the eyes with the camera-captured image on a display as the output apparatus 25. By doing so, the output control unit 214 may position both eyes of the target at predetermined positions within the camera's field of view.

The acquisition unit 211 may acquire an image captured in case a predetermined light source illuminates the target. The predetermined light source may irradiate non-visible light. The predetermined light source may irradiate near-infrared light. The predetermined light source may irradiate light that produces a reflection area of a predetermined size and shape within a glasses area in the image and outside the iris area in case the target is wearing glasses of a predetermined power.

The glasses determination unit 212 determines whether the target in the image is wearing glasses (step S21). In case the target is wearing glasses (step S21: Yes), the suitability determination unit 213 determines whether the image is suitable for use as registration information for biometric recognition (step S22).

Specifically, the reflection area detection unit 2131 detects the reflection area of light corresponding to the glasses area in the image. This reflection area of light is an area produced by the reflection of light irradiated from a predetermined light source. The reflection area detection unit 2131 may detect areas in the image whose brightness is higher than a predetermined value as the reflection area. The predetermined value is a value used to determine whether an area is a high-brightness area, and may be set as a fixed value in advance. Alternatively, the predetermined value may be set as a variable value corresponding to, for example, the average brightness of the glasses area.

By the way, in case glasses are used to correct refractive errors, the target seen through the glasses becomes distorted. The degree of distortion of the target seen through the glasses varies depending on the power of the glasses. In case the power of the glasses is strong, the distortion of the target seen through the glasses becomes larger. Therefore, in case the power of the glasses worn by the target is strong, it is often difficult to acquire iris information of sufficient quality for biometric recognition.

Additionally, in case the glasses are used to correct refractive errors, the reflection area of light becomes distorted. The degree of distortion in the reflection area of light varies depending on the power of the glasses. In case the power of the glasses is strong, the distortion in the reflection area of light increases.

Therefore, the information processing apparatus 2 according to this embodiment determines the power of the glasses using the glasses area in the image. Specifically, the power determination unit 2132 determines the power of the glasses based on the degree of distortion of the detected reflection area. The power determination unit 2132 may determine whether the iris area in the image is likely to be affected by the power of the glasses based on the degree of distortion of the detected reflection area. The degree of distortion may be represented by changes in shape, position, brightness, color, etc. The shape change includes a size change. The information processing apparatus 2 according to this embodiment determines whether the iris area is distorted to an extent that it cannot be used for biometric recognition based on an indicator of distortion included in the glasses area. The power determination unit 2132 may be rephrased as determining whether distortion caused by the power of the glasses is likely to occur in the iris area within the image in case the target is wearing the glasses.

For example, in case the detected distortion of the reflection area exceeds a predetermined threshold, the suitability determination unit 213 may determine that the target needs to remove the glasses. In case the detected distortion of the reflection area exceeds a predetermined threshold, it is likely that the iris area within the image is unsuitable for use as the registration information for biometric recognition. The iris area within the image is an area within the glasses area, so it can be considered to be distorted in the same way as the reflection area associated with the glasses area. In case the distortion is above the specified threshold, it becomes impossible to ensure the performance of biometric recognition, so the suitability determination unit 213 determines that the glasses must be removed. The degree of distortion of the reflection area that is acceptable to the suitability determination unit 213 is determined based on a statistically derived reference.

In addition to determining the power of the glasses, the suitability determination unit 213 may also determine the degree of dirt on the lenses of the glasses, the transmittance of the lenses of the glasses, and other factors. For example, the suitability determination unit 213 may determine that the target needs to remove the glasses in case the lenses of the glasses are dirty to a certain extent or more. In addition, the suitability determination unit 213 may determine that the target needs to remove the glasses in case the transmittance of the lenses of the glasses does not meet the reference. Furthermore, the suitability determination unit 213 may determine that the target needs to remove the glasses in case the reflection area of light related to the glasses area covers the iris area to a certain extent or more.

In case the target needs to remove the glasses (Step S23: Yes), the output control unit 214 outputs guidance information indicating that the target should remove the glasses the target is wearing and reacquire the image (Step S24). The acquisition unit 211 reacquires an image including the eye area of the target (step S25). The operation in step S25 may be the same as the operation in step S20. For example, the output control unit 214 may output the guide information output in step S20.

The glasses determination unit 212 determines whether the target in the image captured in step S25 is wearing the glasses (step S26). In case the target is not wearing the glasses (step S26: No), return to step S24. In case the target is wearing the glasses (step S26: Yes), and the target does not need to remove the glasses (step S23: No), or the target is not wearing the glasses (step S21: No), the iris detection unit 215 detects the iris area from the image (step S27). The iris area detected may be used as registration information for biometric recognition.

### 2-3: Technical Effects of the Information Processing Apparatus 2

In order to ensure recognition performance in biometric recognition, it is important to acquire clear biometric information. In case of acquiring iris information of the target as information to be used for biometric recognition, in case the target is wearing glasses, it is often necessary to have the target remove the glasses in all cases. Additionally, in case of acquiring iris information of the target, it is common to guide the target using the guide information displayed on a display or the like. In this case, the target who has removed the glasses cannot see the guide information. Therefore, without support such as photography by a third party, it was often difficult to properly capture an image including the iris.

The information processing apparatus 2 according to the second embodiment captures an image including the eye area regardless of whether the target is wearing glasses. Therefore, even in case the target is wearing glasses, in case the power of the glasses is weak and the influence caused by the glasses is small, it is not necessary to take another picture, which improves the convenience for the target. On the other hand, in case the glasses worn by the target have a strong power and the effects caused by the glasses are significant, the glasses are removed and the image is captured again. In this case as well, since the target has experience of being captured while wearing glasses and able to see the guide information, the image including the iris can be appropriately captured with less support than in case the target has not experienced being captured while able to see the guide information.

That is, even in case a target has poor eyesight, based on his or her own successful experience, the target can appropriately capture an image including the iris with little support, improving convenience for the target. The information processing apparatus 2 according to the second embodiment improves the convenience for the target and maintains the recognition performance related to biometric recognition.

### 3: Third Example Embodiment

Next, the third embodiment of the information processing apparatus, information processing method, and recording medium will be described. In the following, the third embodiment of the information processing apparatus, information processing method, and recording medium will be described using an information processing apparatus 3 to which the third embodiment of the information processing apparatus, information processing method, and recording medium is applied.

### 3-1: Configuration of the Information Processing Apparatus 3

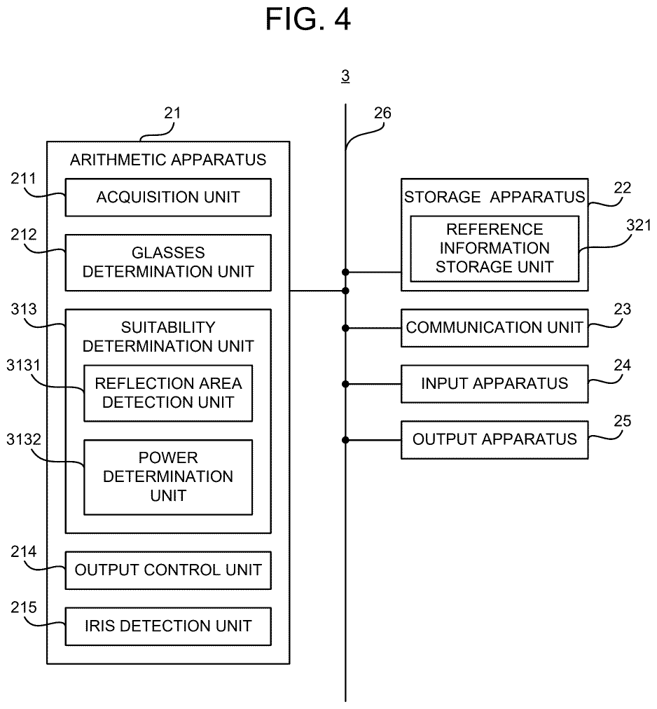

As shown in FIG. 4, the information processing apparatus 3 according to the third embodiment is provided with the arithmetic apparatus 21 and the storage apparatus 22, as in the information processing apparatus 2 according to the second embodiment. Furthermore, the information processing apparatus 3 according to the third embodiment may include the communication apparatus 23, the input apparatus 24, and the output apparatus 25, as in the information processing apparatus 2 according to the second embodiment. However, the information processing apparatus 3 may not necessarily include at least one of the communication apparatus 23, the input apparatus 24, and the output apparatus 25. The information processing apparatus 3 according to the third embodiment differs from the information processing apparatus 2 according to the second embodiment in that a reference information storage unit 321 is provided in the storage apparatus 22. The reference information storage unit 321 stores reference information indicating the reflection area of light irradiated by a predetermined light source corresponding to a predetermined glasses area in the image. The predetermined power may be zero.

The other features of the information processing apparatus 3 may be the same as the other features of the information processing apparatus 2 according to the second embodiment. For this reason, the following description will explain in detail the parts that differ from the embodiments already described, and omit explanations of other overlapping parts as appropriate.

### 3-2: Information Processing Operation Performed by the Information Processing Apparatus 3

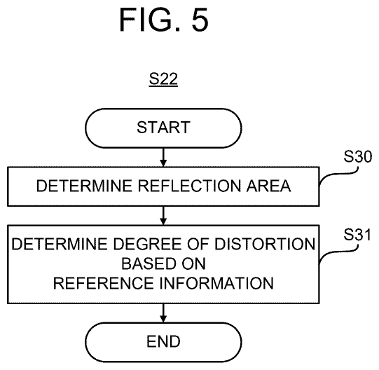

Referring to FIG. 5, the flow of a suitability determination operation performed by the information processing apparatus 3 will be described. FIG. 5 is a flowchart showing the flow of operations related to step S22 shown in FIG. 3.

As shown in FIG. 5, a reflection area detection unit 3131 detects the reflection area of light irradiated by a predetermined light source related to the glasses area in the image (step S30). A power determination unit 3132 makes a determination regarding the power of the glasses based on the reflection area related to the glasses area and the reference information stored in the reference information storage unit 321 (step S31).

For example, the power determination unit 3132 may compare the reflection area corresponding to the glasses area with the reflection area indicated by the reference information to determine the degree of distortion of the reflection area corresponding to the glasses area. The power determination unit 3132 may determine the power of the glasses based on the degree of distortion of the reflection area corresponding to the glasses area. The power determination unit 3132 may determine that the power of the glasses is stronger as the reflection area related to the glasses area differs from the reflection area indicated by the reference information.

Furthermore, the information processing apparatus 3 may pre-determine the correspondence between the degree of difference between the reflection areas and the power of the glasses, and store a table of such correspondence. In this case, the power determination unit 3132 may refer to the table of the correspondence to directly determine the power of the glasses.

The information processing apparatus 3 may use multiple light sources. In this case, the reference information storage unit 321 stores the reference information for each light source, and the power determination unit 3132 may determine the power of the glasses based on the reference information corresponding to the relevant light source.

### 3-3: Technical Effects of the Information Processing Apparatus 3

The information processing apparatus 3 according to the third embodiment uses reference information indicating the reflection area corresponding to the area of glasses with a predetermined power, thereby enabling a more accurate determination of the power of the glasses.

### 4: Fourth Example Embodiment

Next, the fourth embodiment of the information processing apparatus, information processing method, and recording medium will be described. In the following, the fourth embodiment of the information processing apparatus, information processing method, and recording medium will be described using an information processing apparatus 4 to which the fourth embodiment of the information processing apparatus, information processing method, and recording medium is applied.

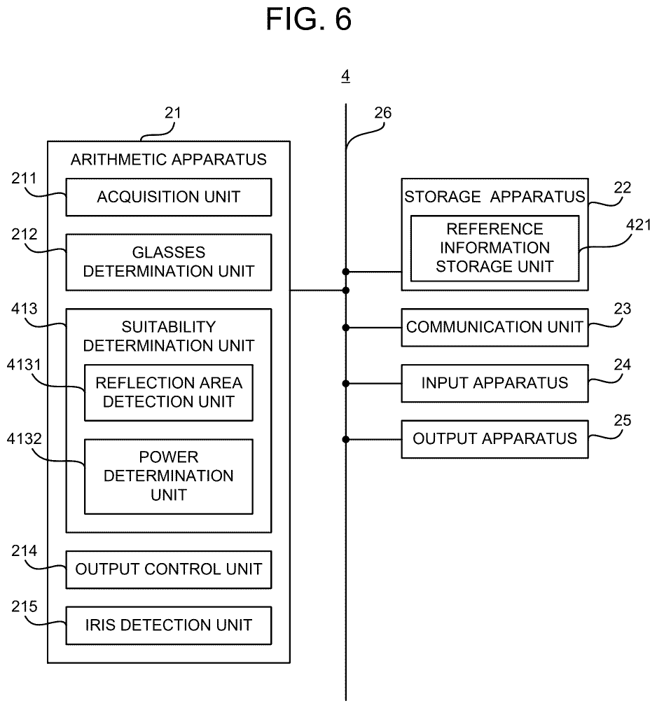

FIG. 6 is a block diagram showing the configuration of the information processing apparatus 4 according to the fourth embodiment. The information processing apparatus 4 according to the fourth embodiment differs from the information processing apparatus 2 according to the second embodiment and the information processing apparatus 3 according to the third embodiment in that the operation of a suitability determination unit 413 is different.

In the fourth embodiment, the reflection area includes a front side reflection area where the front side of the lens of the glasses reflects light and a back side reflection area where the back side of the lens of the glasses reflects light. The front side of the lens of the glasses is the surface that does not face the target's eyes, and the back side of the lens of the glasses is the surface that faces the target's eyes. The front side reflection area is the reflection area where light from the light source is reflected toward the target, and the back side reflection area is the reflection area where light from the target is reflected toward the camera.

### 4-1: Information processing performed by the information processing apparatus 4

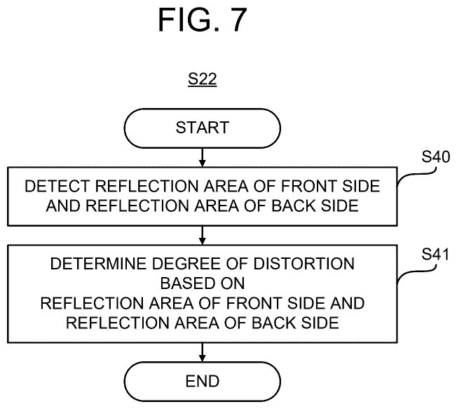

Referring to FIG. 7, the flow of the suitability determination operation performed by the information processing apparatus 4 is described. FIG. 7 is a flowchart showing the flow of operations related to step S22 shown in FIG. 3.

A reflection area detection unit 4131 detects the front side reflection area and the back side reflection area related to the glasses area in the image (step S40). A power determination unit 4132 makes a determination regarding the power of the glasses based on the degree of distortion of the front side reflection area and the degree of distortion of the back side reflection area (step S41).

A reference information storage unit 421 may store front side reference information indicating the front side reflection area of light irradiated by a predetermined light source corresponding to the area of glasses with a predetermined power in the image, and back side reference information indicating the back side reflection area of the light. The predetermined power may be zero. The power determination unit 4132 may determine the power of the glasses based on the determination based on the front side reflection area and the front side reference information, and the determination based on the back side reflection area and the back side reference information. Furthermore, the power determination unit 4132 may determine the power of the glasses based on the relative relationship between the front side reflection area and the back side reflection area. For example, the power of the glasses may be determined based on the relative relationship between the shape of the front side reflection area and the shape of the back side reflection area. Furthermore, it is possible to determine the power of the glasses based on the relative relationship between the position of the front side reflection area and the position of the back side reflection area. It is also possible to determine the power of the glasses based on the relative relationship between the brightness of the front side reflection area and the brightness of the back side reflection area. Furthermore, it is possible to determine the power of the glasses based on the relative relationship between the color of the front side reflection area and the color of the back side reflection area.

### 4-2: Technical Effects of the Information Processing Apparatus 4

The information processing apparatus 4 according to the fourth embodiment uses two types of reflection areas, thereby enabling a more accurate determination of the power of the glasses.

### 5: Fifth Example Embodiment

Next, the fifth embodiment of the information processing apparatus, information processing method, and recording medium will be described. In the following, the fifth embodiment of the information processing apparatus, information processing method, and recording medium will be described using an information processing apparatus 5 to which the fifth embodiment of the information processing apparatus, information processing method, and recording medium is applied.

### 5-1: Configuration of the Information Processing Apparatus 5

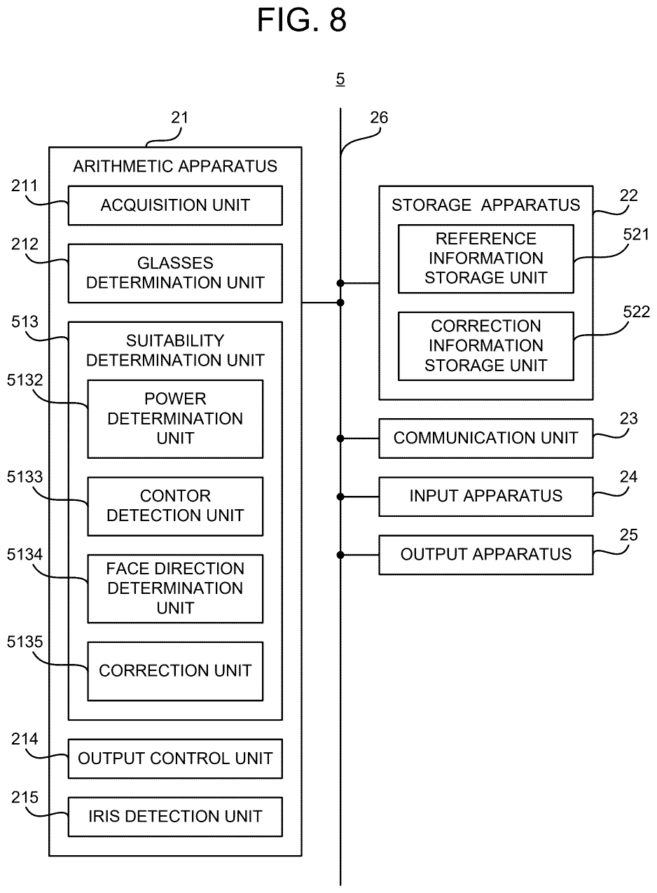

As shown in FIG. 8, the information processing apparatus 5 according to the fifth embodiment is provided with the arithmetic apparatus 21 and the storage apparatus 22, as in the information processing apparatus 2 according to the second embodiment through the information processing apparatus 4 according to the fourth embodiment. Furthermore, the information processing apparatus 5 according to the fifth embodiment may include the communication apparatus 23, the input apparatus 24, and the output apparatus 25, as in the information processing apparatus 2 according to the second embodiment through the information processing apparatus 4 according to the fourth embodiment. However, the information processing apparatus 5 may not include at least one of the communication apparatus 23, the input apparatus 24, and the output apparatus 25. The information processing apparatus 5 according to the fifth embodiment differ from the information processing apparatus 2 according to the second embodiment through the information processing apparatus 4 according to the fourth embodiment in that a suitability determination unit 513 further includes a correction unit 5135, a face direction determination unit 5134, and a correction unit 5135. Other features of the information processing apparatus 5 may be the same as at least one other feature of the information processing apparatus 2 according to the second embodiment through the information processing apparatus 4 according to the fourth embodiment. For this reason, the following description will explain in detail the parts that differ from the embodiments already described, and omit explanations of other overlapping parts as appropriate.

### 5-2: Information Processing Operations Performed by the Information Processing Apparatus 5

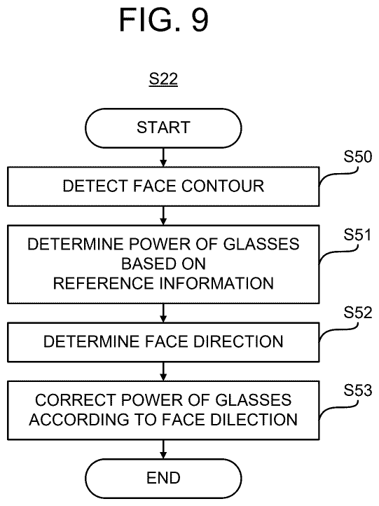

Referring to FIG. 9, the flow of the suitability determination operation performed by the information processing apparatus 5 will be described. FIG. 9 is a flowchart showing the flow of operations corresponding to step S22 shown in FIG. 3.

As shown in FIG. 9, the contour detection unit 5133 detects the contour of the face of the target included in the image. The contour detection unit 5133 detects, from among the contours of the face of a target included in the image, a first contour in the glasses area in the image and a second contour in an area other than the glasses area adjacent to the first contour (step S50).

A power determination unit 5132 makes a determination regarding the power of the glasses based on the first contour and the second contour (step S51). The power determination unit 5132 makes the determination regarding the power of the glasses based on a difference between the first contour and the second contour. The power determination unit 5132 determines that the power of the glasses is stronger as the difference between the first contour and the second contour is larger.

A reference information storage unit 521 may store the reference information indicating the difference between the first contour and the second contour corresponding to a predetermined power of glasses in images. In this case, the power determination unit 5132 may compare the difference between the first contour and the second contour with the reference information to determine the power of the glasses.

The face direction determination unit 5134 determines the direction of the face of the target included in the image (step S52). The correction unit 5135 corrects the determination result of the power determination unit 5132 according to the direction of the face determined by the face direction determination unit 5134 (step S53). Since the degree of distortion related to the glasses area changes depending on the face direction of the target, and the difference between the first contour and the second contour changes, the correction unit 5135 corrects the determination result of the power determination unit 5132 according to the face direction.

A correction information storage unit 522 may store the power of the glasses determined and the face tilt, and the power of the glasses after correction in a corresponding manner. In this case, the correction unit 5135 may correct the determination result of the power determination unit 5132 by referring to the correction information storage unit 522.

In this embodiment, the case where the difference between the first contour and the second contour is used as an index of distortion in the glasses area has been descried, but the index of distortion in the glasses area may be the distortion of the reflection area in the glasses area. In other words, the correction unit 5135 may correct the power of the glasses determined based on the degree of distortion of the reflection area of light related to the glasses area in the image in accordance with the face direction determined by the face direction determination unit 5134.

### 5-3: Technical Effects of the Information Processing Apparatus 5

The information processing apparatus 5 according to the fifth embodiment can make a proper determination of the power of the glasses even in case the face is not facing forward. In addition, the information processing apparatus 5 can make a determination of the power of the glasses based on the contour of the face.

### 6: Sixth Example Embodiment

Next, the sixth embodiment of the information processing apparatus, information processing method, and recording medium will be described. In the following, the sixth embodiment of the information processing apparatus, information processing method, and recording medium will be described using an information processing apparatus 6 to which the sixth embodiment of the information processing apparatus, information processing method, and recording medium is applied.

### 6-1: Configuration of the Information Processing Apparatus 6

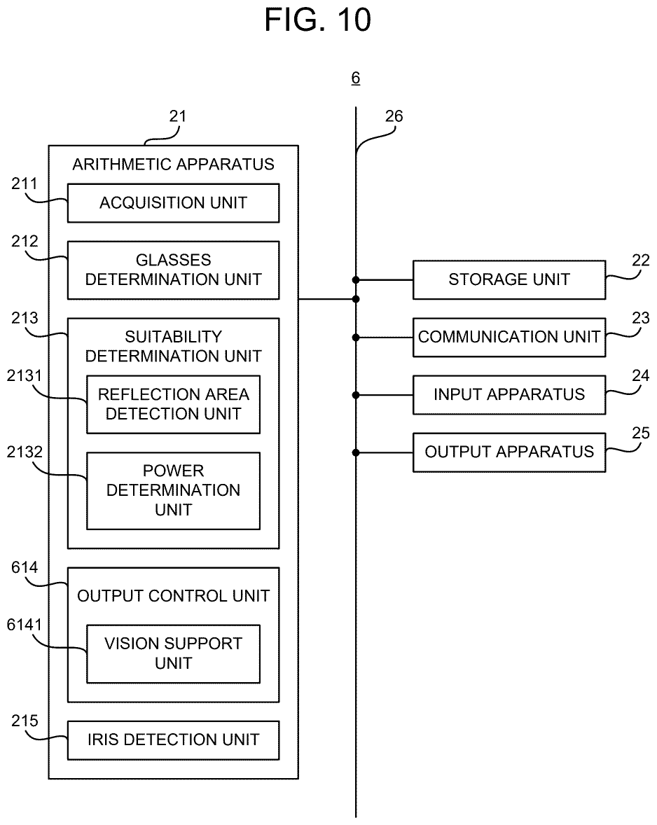

As shown in FIG. 10, the information processing apparatus 6 according to the sixth embodiment includes the arithmetic apparatus 21 and the storage apparatus 22, which is derived from the information processing apparatus 2 according to the second embodiment through the information processing apparatus 5 according to the fifth embodiment. Furthermore, the information processing apparatus 6 according to the sixth embodiment may include the communication apparatus 23, the input apparatus 24, and the output apparatus 25, as in the information processing apparatus 2 according to the second embodiment through the information processing apparatus 5 according to the fifth embodiment. However, the information processing apparatus 6 may not include at least one of the communication apparatus 23, the input apparatus 24, and the output apparatus 25. The information processing apparatus 6 according to the sixth embodiment differs from the information processing apparatus 2 according to the second embodiment through the information processing apparatus 5 according to the fifth embodiment in that an output control unit 614 includes a vision support unit 6141. Other features of the information processing apparatus 6 may be identical to at least one other feature of the information processing apparatus 2 according to the second embodiment through the information processing apparatus 5 according to the fifth embodiment. For this reason, the following description will detail the parts that differ from the embodiments already described, omitting explanations of other overlapping parts as appropriate.

### 6-2: Output Operation of Guidance Performed by the Information Processing Apparatus 6

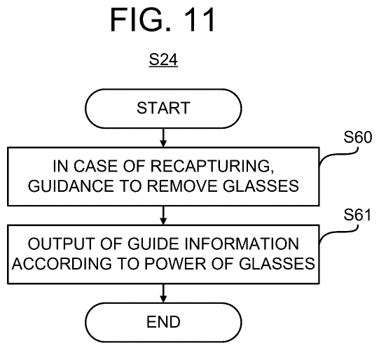

Referring to FIG. 11, the flow of the output operation of guidance performed by the information processing apparatus 6 will be described. FIG. 11 is a flowchart showing the flow of operations corresponding to step S24 shown in FIG. 3.

As shown in FIG. 11, the output control unit 614 outputs guidance information indicating that the target should remove the glasses being worn and acquire the image again, in accordance with the determination result of the power determination unit 2132 (step S60). The vision support unit 6141 outputs support information corresponding to the power of the glasses of the target that has removed the glasses, which is imaged on the retina of the target (step S61). The support information is information that assists in reacquiring the image and may be the same as the guide information output by the output control unit 214 in steps S20 and S25. The target without glasses cannot perceive the information that could be perceived in case of wearing glasses. The information that was imaged on the retina of the target in case the glasses were worn is not imaged on the retina of the target in case the glasses are removed. Therefore, the information processing apparatus 6 according to the sixth embodiment corrects the information output by the information processing apparatus 6 instead of correcting with glasses, so that the target can see the information in case the glasses are removed. Therefore, the target can perceive the same guide information that was perceivable in case of wearing glasses, even in case glasses are removed.

### 6-3: Technical Effect of the Information Processing Apparatus 6

The information processing apparatus 6 according to the sixth embodiment enables the target to see the same guide information that could be seen in case of wearing glasses even in case the glasses are removed.

### 7: Supplementary Note

The following supplementary note is disclosed regarding the embodiments described above.

### Supplementary Note 1

An information processing apparatus including:
an acquisition means for acquiring an image including an eye area of a target;
a glasses determination means for determining whether the target included in the image is wearing glasses;
a power determination means for determining a power of the glasses based on the image in case the target is wearing glasses; and
an output means for outputting information to the target depending on the power determination result of the power determination means.

### Supplementary Note 2

The information processing apparatus according to Supplementary Note 1, further including
a reflection area detection means for detecting a reflection area of light irradiated by a predetermined light source in a glasses area of the glasses in the image, wherein
the power determination means makes a determination regarding the power of the glasses based on a degree of distortion of the reflection area.

### Supplementary Note 3

The information processing apparatus according to Supplementary Note 2, further including
a storage means for storing reference information indicating the reflection area of light emitted by the specified light source in an area of glasses of a specified power in the image, wherein
the power determination means makes the determination regarding the power of the glasses based on the reflection area detected by the reflection area detection means and the reference information stored in the storage means.

### Supplementary Note 4

The information processing apparatus according to Supplementary Note 2 or 3, wherein
the reflective area includes a first reflection area of reflection from a first surface of a lens of the glasses facing an eye of the target and a second reflection area of reflection from an opposite surface of the first surface.

### Supplementary Note 5

The information processing apparatus according to Supplementary Note 1, further including
a contour detection means for detecting, from contours of a face of the target included in the image, a first contour in a glasses area of the glasses in the image and a second contour in an area other than the glasses area adjacent to the first contour, wherein
the power determination means determines the power of the eyeglasses based on the first contour and the second contour.

### Supplementary Note 6

The information processing apparatus according to any one of Supplementary Notes 1 to 5, further including:

a direction determination means for determining a direction of a face of the target included in the image; and
a correction means for correcting the power determination result of the power determination means according to the direction of the face.

### Supplementary Note 7

The information processing apparatus according to any one of Supplementary Notes 1 to 6, wherein
the output means outputs guidance information to the target instructing to remove the glasses and to acquire the image according to the power determination result of the power determination means, and
the output means outputs support information to assist in acquiring the image that is imaged on a retina of the target who has removed the glasses according to the power of the glasses.

### Supplementary Note 8

An information processing method including:
acquiring an image including an eye area of a target;
determining whether the target included in the image is wearing glasses;
determining a power of the glasses based on the image in case the target is wearing glasses; and
outputting information to the target depending on the power determination result.

### Supplementary Note 9

A recording medium on which a computer program is stored, the computer program being configured to allow a computer to execute an information processing method including:
acquiring an image including an eye area of a target;
determining whether the target included in the image is wearing glasses;
determining a power of the glasses based on the image in case the target is wearing glasses; and
outputting information to the target depending on the power determination result.

This disclosure may be changed as appropriate within the scope of the technical concept that can be read from the claims and the entire specification. Information processing apparatus, information processing methods, and recording media involving such changes are also included in the technical concept of this disclosure.

### DESCRIPTION OF REFERENCE CODES

1, 2, 3, 4, 5, 6 information processing apparatus
11, 211 acquisition unit
12, 212 glasses determination unit
13, 2132, 3132, 4132, 5132 power determination unit
14 output unit
213, 313, 413, 513 suitability determination unit
2131, 3131, 4131 reflection area detection unit
214, 614 output control unit
215 iris detection unit
321, 421, 521 reference information storage unit
5133 contour detection unit
5134 face direction determination unit
5135 correction unit
522 correction information storage unit
6141 vision support unit

What is claimed is:

1. An information processing apparatus comprising:
at least one memory storing instructions; and
at least one processor that is configured to execute the instructions to:
acquire an image including an eye area of a target;
determine whether the target included in the image is wearing glasses;
determine a power of the glasses based on the image in case the target is wearing glasses; and
output information to the target depending on the power determination result.

2. The information processing apparatus according to claim 1, wherein at least one processor that is configured to execute the instructions to:
detect a reflection area of light irradiated by a predetermined light source in a glasses area of the glasses in the image; and
make a determination regarding the power of the glasses based on a degree of distortion of the reflection area.

3. The information processing apparatus according to claim 2, wherein at least one processor that is configured to execute the instructions to:
store reference information indicating the reflection area of light emitted by the specified light source in an area of glasses of a specified power in the image, in the at least one memory; and
make the determination regarding the power of the glasses based on the reflection area detected and the reference information stored in the at least one memory.

4. The information processing apparatus according to claim 2, wherein
the reflective area includes a first reflection area of reflection from a first surface of a lens of the glasses facing an eye of the target and a second reflection area of reflection from an opposite surface of the first surface.

5. The information processing apparatus according to claim 1, wherein at least one processor that is configured to execute the instructions to:
detect from contours of a face of the target included in the image, a first contour in a glasses area of the glasses in the image and a second contour in an area other than the glasses area adjacent to the first contour; and
determine the power of the eyeglasses based on the first contour and the second contour.

6. The information processing apparatus according to claim 1, wherein at least one processor that is configured to execute the instructions to:
determine a direction of a face of the target included in the image; and
correct the power determination result according to the direction of the face.

7. The information processing apparatus according to claim 1, wherein at least one processor that is configured to execute the instructions to:
output guidance information to the target instructing to remove the glasses and to acquire the image according to the power determination result; and
output support information to assist in acquiring the image that is imaged on a retina of the target who has removed the glasses according to the power of the glasses.

8. An information processing method comprising:
acquiring an image including an eye area of a target;
determining whether the target included in the image is wearing glasses;
determining a power of the glasses based on the image in case the target is wearing glasses; and
outputting information to the target depending on the power determination result.

9. A non-transitory recording medium on which a computer program is stored, the computer program being configured to allow a computer to execute an information processing method comprising:
acquiring an image including an eye area of a target;
determining whether the target included in the image is wearing glasses;
determining a power of the glasses based on the image in case the target is wearing glasses; and
outputting information to the target depending on the power determination result.
